(19) United States
(12) Patent Application Publication
(10) Pub. No.: US 2023/0011867 A1
(43) Pub. Date: Jan. 12, 2023

(54) Battery Energy Storage System for Powering an Electro-Mechanical Workover Rig

(71) Applicant: Bazean Corp., Houston, TX (US)

(72) Inventors: Abhishek Arya, Houston, TX (US); Robert Kendall, Houston, TX (US); Jeffrey Michael LeBlanc, Houston, TX (US); Samuel Newman, Boston, ME (US)

(73) Assignee: Bazean Corp., Houston, TX (US)

(21) Appl. No.: 17/811,038

(22) Filed: Jul. 6, 2022

Related U.S. Application Data
(60) Provisional application No. 63/203,045, filed on Jul. 6, 2021.

(51) Int. Cl. H01M 10/42; E21B 41/00; H01M 50/204; H01M 50/251; H01M 50/242; H01M 10/48; H01M 10/613; H01M 10/627; H01M 10/6567; H01M 10/0525

(52) U.S. Cl. CPC H01M 10/425; E21B 41/00; H01M 50/204; H01M 50/251; H01M 50/242; H01M 10/482; H01M 10/613; H01M 10/627; H01M 10/6567; H01M 10/0525; H02J 7/005

(57) ABSTRACT

A system for powering 100% of an oil and gas workover rig's operations with a battery energy storage system (“BESS”). The system consists of three major interconnected components: a BESS, a power conversion system (“PCS”), and a workover rig. The power system is specifically designed for a retrofitted electro-mechanical workover rig (with either an alternating current or direct current electric drive) which is compatible with the BESS. Unlike other emerging industrial applications, a battery cannot be mounted on the workover rig due to logistical and size constraints, thus requiring a novel modular and mobile system design.

### CROSS-REFERENCE TO RELATED APPLICATION

This Patent Application claims priority to U.S. Provisional Patent Application No. 63/203,045 filed on Jul. 6, 2021, entitled “Battery Energy Storage System for Powering an Electro-Mechanical Workover Rig.” The disclosure of the prior application is considered part of and is incorporated by reference into this Patent Application.

### TECHNICAL FIELD

The present invention relates to the field of workover rigs used for oil and gas operations, and in particular to a system and technique for powering a retrofitted electro-mechanical workover rig with a battery energy storage system (“BESS”).

### BACKGROUND ART

In oil and gas operations, workover rigs are utilized for well intervention, which may involve services like maintenance, repair, stimulation, and the plugging and abandonment (“P & A”) of wellbores. The rigs vary in scale and specific components but generally consist of a hoisting system, a circulation system, a rotation system, a power system, and a well control system. The prime movers within the power system are generally internal combustion engines reliant on diesel fuel.

As greenhouse gas emissions have come under increased scrutiny, a demand has arisen for cleaner oilfield operations with equipment powered by lower-emission power sources such as electricity rather than hydrocarbons. Simultaneously, the decrease in lithium-ion battery prices has rendered batteries increasingly cost-competitive with hydrocarbon-based fuels in various applications.

In the construction industry, self-mounted batteries are in the early stages of adoption for heavy-duty equipment as an alternative to internal combustion engines. However, for a workover rig, its daily power requirements render this self-mounted design infeasible as there is not enough physical space to mount a sufficient battery onto a rig. Workover rig manufacturers have thus far failed to develop a system that enables using batteries as a primary power source for the workover rig use case.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is an illustrative top view of the BESS and its various components.

FIG. 2 is an illustrative front view of a battery rack and its vibration-resistant features.

FIG. 3A is a block drawing of a direct connection between a variable frequency drive (VFD) and a DC power source where the DC power source connects to the VFD via the DC bus terminal.

FIG. 3B is a block drawing of an indirect connection between a VFD and DC power source where the DC power connects to an inverter which in turn connects to the VFD's primary end.

FIG. 4 is a block drawing illustrating a configuration for connecting a BESS to a retrofitted electro-mechanical rig and the integration of a computer system into the BESS, PCS, and rig systems.

FIG. 5 is a simplified block diagram of a mechanical workover rig according to the prior art.

FIG. 6 is a block diagram illustrating a retrofit workover rig that is configured for towing by a secondary vehicle, such as a truck.

FIG. 7 is a block diagram illustrating a truck-mounted retrofit workover rig wherein the main engine is replaced by a smaller engine that powers the axles of the truck-mounted workover rig.

FIG. 8 is a block diagram illustrating a retrofit rig where an electric motor powers the axles of the truck-mounted workover rig.

FIG. 9 is a block diagram illustrating a mechanical drawworks being run with an electric motor by locking a variable speed transmission of the drawworks in a single gear ratio.

FIG. 10 is a block diagram illustrating a mechanical drawworks being run with an electric motor by direct connection after removing a variable speed transmission of the drawworks.

FIG. 11 is a block diagram illustrating a mechanical drawworks being run with an electric motor by connecting to a variable speed transmission of the drawworks, retaining the functionality of the transmission.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instances of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation.

While larger rigs (e.g., 1000-2000 hp) capable of drilling horizontal wells may use a BESS for peak shaving or as an emergency power source, the power requirements of 24/7 operations cannot be logistically met by a BESS given the current energy density of lithium-ion batteries. Conversely, the power requirement of a mobile truck-mounted workover rig can be met with a BESS given its dramatically lower horsepower rating (generally up to 600 hp) and the fact that most workover jobs are generally 12-hour operations. Furthermore, such non-continuous operations allow for the design of a modular power system, where a discharged BESS may be swapped out for a fully charged BESS during off-hours without affecting operations. This feature enables the system to operate in remote areas where the electrical grid is inaccessible, a common circumstance for the oil and gas industry.

While manufacturers are beginning to offer mobile energy storage solutions, they are usually offered in a standard intermodal container with minimal consideration to resisting vibration caused by rough transport and onsite conditions.

Vibrations have been shown to cause performance degradation in lithium-ion batteries due to increases in cell degradation, impedance, resistance, and capacity loss with the degree of degradation dependent on the frequency and duration of the induced vibrations and battery chemistry. Studies suggest a strong need to protect batteries against vibrations for optimal performance.

In another study, the vibration profile representative of a typical 10-year European vehicle life resulted in no material degradation for Nickel Cobalt Aluminum Oxide batteries. Results from this study can also be inferred as for a well-designed vehicle, where the battery is supported by a suspension system with an anti-resonant and vibration-resistant design, it is possible to completely protect the battery from the negative effects of vibration.

Oil & gas operations also necessitate a high degree of vibration resistance compared to commercial electric vehicles given their rugged transportation conditions (e.g., driving over temporary dirt and gravel roads) and their extended time in transit with typical jobs only lasting several days. The BESS may also be subject to vibrations originating from the rig itself during operations, and though the distance between the BESS and the rig may help mitigate the vibrations, additional vibration resistance should be accounted for in the design as a precaution. Manufacturers currently have no BESS design to account for the operating conditions for a typical workover rig and provide optimal battery performance.

A retrofitted electro-mechanical rig is a mechanical rig whose internal combustion engine has been replaced with an electric motor according to the technique described below.

The modified power system is comprised of three major components with electricity (i) originating in the BESS, (ii) managed by the PCS, and (iii) consumed by the electro-mechanical workover rig.

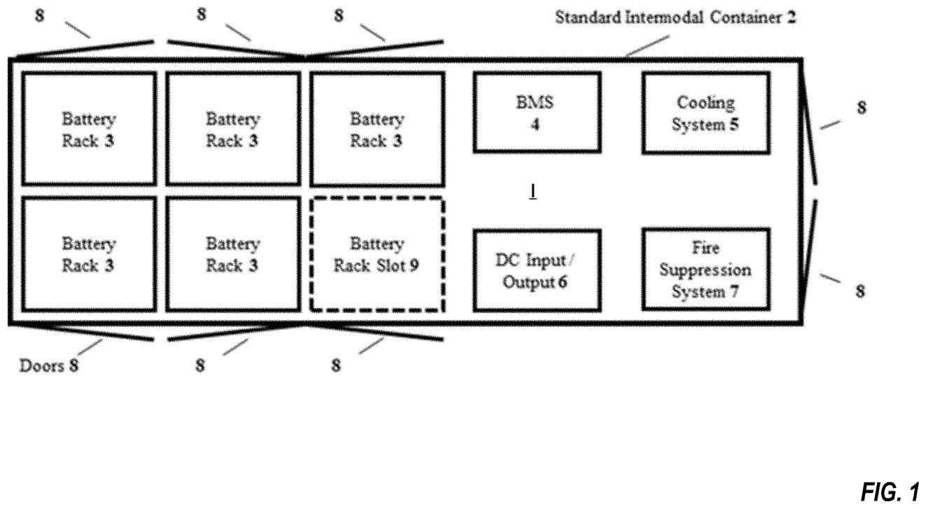

The BESS 1 may be comprised of a standard intermodal container (“container”) 2, battery racks 3, a battery management system (BMS) 4, a cooling system 5, a DC power input/output unit 6, and a fire suppression system 7 as illustrated in FIG. 1. The container 2 houses the BESS 1, protects the BESS 1 from outside environmental factors and creates an internal environment for the cooling system 5 to manage. Doors 8 located around the container allow for direct access to the battery racks 3 during maintenance. Although only a single cooling system 5, a single DC power input/output unit 6, and a single fire suppression system 7 are illustrated in FIG. 1, multiple cooling systems, DC power input/output units, and fire suppression systems may be used as desired.

While the battery racks 3 are the nominal components of the BESS 1, the BMS 4 and cooling system 5 serve a critical role, preserving the optimal functionality of the BESS 1. The BMS 4 monitors battery health down from individual cells up to the rack and system level to increase the reliability and longevity of the BESS 1. The cooling system 5 is responsible for maintaining the temperature inside the BESS 1 as batteries often reach peak efficiency at operating temperatures between 18°-28° C. and experience longer-term degradation at temperatures above 45° C. heating, ventilation, and air conditioning (HVAC) and/or liquid-cooling systems may be utilized as the cooling system 5 to regulate temperature.

Other components of the BESS 1 may include the DC power input/output unit 6 and the fire suppression system 7. The DC power input/output unit 6 enables the BESS 1 to accept electricity from the grid and discharge stored electricity to a demand sink (e.g., a rig). The fire suppression system 7 is an emergency system that activates to extinguish a low-probability electrical fire.

The battery racks 3 serve two primary functions: (i) organizing the lithium-ion battery modules in series or parallel for the desired use case (voltage and energy output), and (ii) isolating the battery modules from vibrations induced by transit, during operations, or from ancillary systems (such as a HVAC system). While FIG. 1 illustrates a BESS 1 with a capacity of six battery racks 3, (five utilized battery racks 3 and an empty battery rack slot 9), the dimensions of a battery rack 3 may vary depending on the technology utilized in the design. Any number of battery racks 3 may be provided in the BESS 1. The number of battery racks 3 installed in the container 2 is dependent on the power requirements of the rig and additional battery racks 3 can be installed and removed as needed.

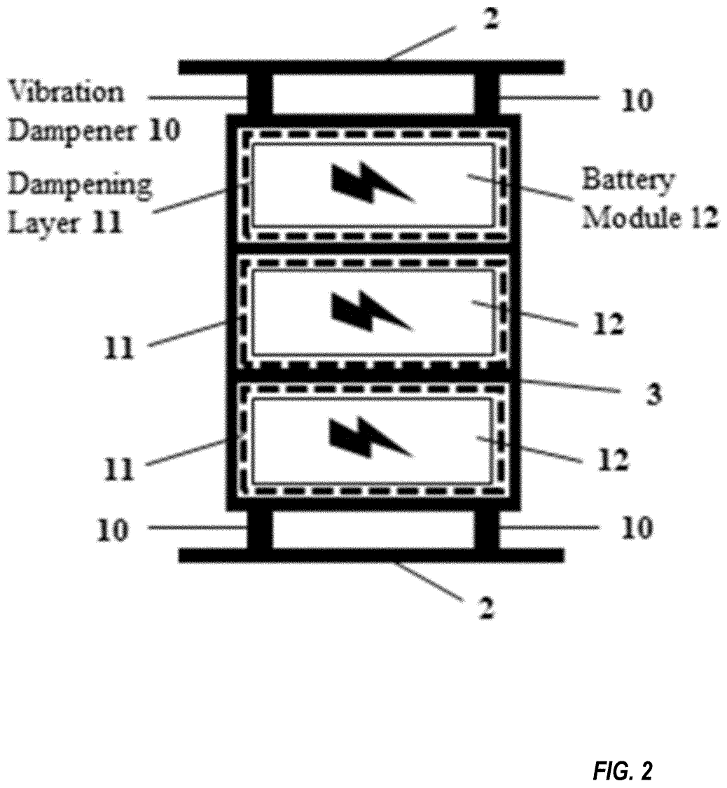

FIG. 2 illustrates how a battery rack 3 utilizes passive vibration dampeners 10 between the ceiling of the container 2 and the top of the battery rack 3, passive vibration dampeners 10 between the floor of the container 2 and the bottom of the battery rack 3, and dampening layers 11 between the battery rack 3 and battery modules 12 to protect the battery modules 12 from vibrations. The design may utilize any type of passive vibration dampeners 10, such as gas springs, air bladders, snubbers, or elastomeric dampers, while the material for the dampening layer 11 may be common elastomers such as silicone rubber or nylon. Although FIG. 2 contains four passive vibration dampeners 10 between the container 2 and the battery rack 3, the number, placement, and type of passive vibration dampeners 10 illustrated in FIG. 2 is illustrative and by way of example only, and the number, placement, and type of passive vibration dampers 10 utilized may be selected dependent upon various factors, such as the weight, center of gravity, and natural frequency of the battery racks 3 and the frequency of the expected vibrations. In other implementations, an active vibration damping system may be used instead of passive vibration dampers 10.

The power control system (PCS) 20 for a retrofitted electro-mechanical workover rig 18 such as described below is dependent on the type of motor(s) (AC or DC) installed during the modification. AC motors utilize a variable frequency drive (VFD) while DC motors require a controller to manage voltage.

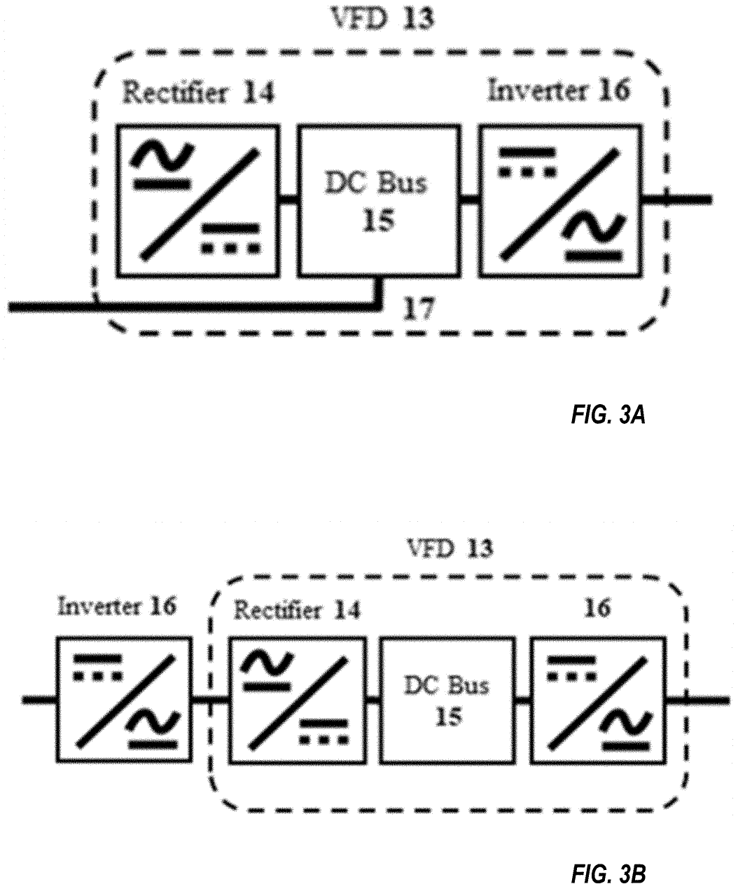

A VFD 13 controls the rotational speed of an AC motor by varying the frequency and voltage of the electricity supplied to the motor. While VFDs 13 typically comprise three primary sections; a rectifier 14, a DC bus 15, and an inverter 16 and take an AC power input; most VFDs 13 are also compatible with a DC power input by allowing a connection directly to a DC bus terminal 17 to bypass the rectifier 14. In the absence of an accessible DC bus terminal 17, one may use an inverter 16 as an intermediary step, converting the DC electricity to AC before flowing through the primary end of the VFD 13. FIG. 3A illustrates a direct connection between a DC power source and a VFD 13 while FIG. 3B illustrates an indirect connection.

The most efficient method to control the speed of a DC motor is by voltage regulation at the input end. A PCS 20 designed for the most optimal energy efficiency hence provides voltage regulation. This may be managed by utilizing a controller for pulse width modulation (PWM). The controller circuit may be designed using high-efficiency semiconductors like field-effect transistors (MOSFET), Insulated Gate Bipolar Transistors (IGBTs), thyristors, etc., utilizing their switching capabilities for PWM. Compared to an AC motor's VFD 13, a DC controller (not shown) is a simpler architecture as only the voltage is regulated, and there is no need for an additional rectifier circuit since the entire circuit is DC.

Depending upon the input voltage requirement of the equipment on the retrofitted rig 18, a step-up/step down transformer (not shown) may be added to the PCS 20 in either of the cases (AC motor or DC motor) to aid in proper voltage conversion between power output from the BESS 1 to the retrofitted rig equipment power input.

Although described below in terms of a PCS and a motor, systems may employ multiple PCSs and multiple motors that work together or independently as desired.

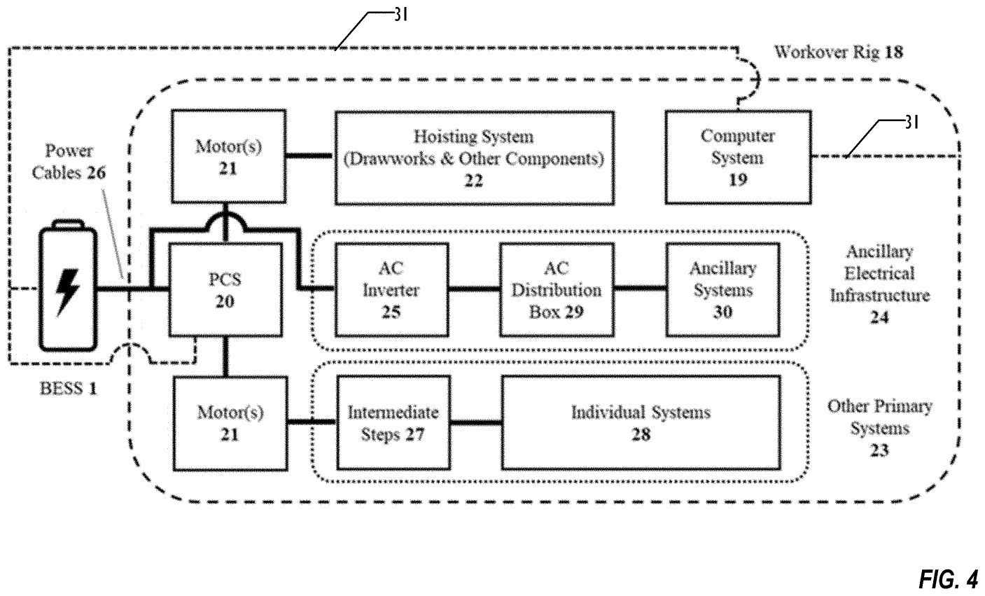

FIG. 4 is a block diagram illustrating a configuration for connecting a BESS 1 to a retrofitted electro-mechanical workover rig 18 and integrating a computer system 19 to aid in the control of the overall system. As illustrated in FIG. 4, electricity flows from the BESS 1 to the PCS 20 before being distributed to the motors 21 that power the primary rig systems 22, 23. Electricity also flows from the BESS 1 to the ancillary electrical infrastructure 24 via the AC inverter 25. The BESS 1 connects to the PCS 20 and the AC inverter 25 via standard power cables 26 whose lengths may vary depending on operational constraints (e.g., pad footprint). Additionally, a second circuit 31 may connect the computer system 19 to the BESS 1, rig 18, and PCS 20.

As disclosed herein, PCS 20 and motor 21 are used generically as a distinction between a DC or AC system is not made since both systems require a similar configuration to accept power from a BESS 1. Furthermore, although each motor may have its own PCS, as used herein PCS 20 refers to the systems collectively.

In some implementations, one or both of the PCS 20 and AC inverter 25 may be disposed external to the workover rig 18 for space or other reasons. In some implementations, the externally disposed PCS 20, AC inverter 25, or both may be placed within the BESS 1. However, keeping the PCS 20 and AC inverter 25 with the rig 18 at a common location may (i) minimize the number of connections between the BESS 1 and the rig 18, (ii) preserve the modularity of the two systems: the system providing power—the BESS 1, and the system drawing power—the rig 18, (iii) reduce the redundancy of equipment needed to run operations and (iv) be more cost effective. This reduced level of complexity may be beneficial for operations, for example, when a discharged BESS 1 is swapped out for a fully charged BESS 1 in the field.

The hoisting system 22 generally comprises a drawworks, a traveling block, a crown block, a deadline anchor, lines, etc. While the hoisting system 22 is only one of several primary rig systems, the power requirements of the drawworks of the hoisting system 22 may use a dedicated motor 21 for higher energy efficiency. The hoisting system 22 is responsible for lifting and lowering the drill string, the drill pipe, and other equipment that connects the rig 18 to activity that may be thousands of feet below the surface. In some implementations, a separate PCS 20 may be dedicated to managing the rotational speed of each motor 21 which converts electrical energy into mechanical energy to power the hoisting system 22.

The other primary systems 23 (e.g., circulation, rotation, well control) may share one motor 21 where power goes through several other intermediary steps 27 before the mechanical energy reaches the individual systems 28. These intermediary steps are discussed in more detail in the retrofit rig section below.

The ancillary electrical infrastructure 24 may comprise an AC inverter 25, an AC distribution box 29, and ancillary electrical systems 30. The AC inverter 25 may be co-located with the PCS 20 and may convert DC electricity from the BESS 1 into AC power. The AC distribution box 29 may also house individual circuit breakers for the ancillary electrical systems 30. Thus, electricity flows from the BESS 1 through the AC inverter 25 and to the AC distribution box 29 through which electricity is distributed to the ancillary electrical systems 30.

A computer system 19 with a custom software may be added to aid in controlling the overall system (BESS 1, PCS 20, and machinery (e.g., the rig systems 22, 23, 24)). This is in addition to the standard BMS 4 that is provided with the BESS 1. This software may be designed to optimize battery life and power management based on the expected oil and gas operations' charge/discharge profile. Both the daily depth of discharge and the power draw profile would vary depending on the operation for that day. For example, for a P & A operation, pulling pipe out of the hole from the deepest part of the well in the initial days would consume large amounts of energy due to heavier hook loads, compared to the final days with minimum pipe left downhole. But since the order of operations is similar for a certain type of job (e.g., P & A), it is possible to use predictive analytics to optimize for battery life based on expected operations and related power draw. Additionally, the software may be artificial intelligence-enabled, capable of self-learning and improving the BMS 4 based on usage in the real world. The computer system 19 may also provide a medium through which operating conditions can be visualized and allow the data to be stored locally or remotely, which can be used for future improvements of the custom software. In special cases where the operator needs to feed in instructions based on changing operating conditions, the computer system 19 may act as an interface between the BESS 1 and the operator.

Retrofit Rig

Workover rigs have been used for many decades in oil & gas operations for wellbore intervention, workover operations, and eventual plugging and abandonment of wellbores. They vary in scale and specific components but generally consist of a hoisting system, a circulation system, a rotation system, a power system, and a well control system. The prime movers within the power system are generally internal combustion engines reliant on diesel fuel.

As greenhouse gas emissions have come under increased scrutiny, a demand for cleaner oilfield operations has arisen with equipment powered by electricity rather than hydrocarbons. There do exist certain large rigs which are available in electric drive modes (generally higher horsepower rigs capable of drilling operations as well as workovers). However, there is currently no accepted method to utilize electricity to drive a workover rig's operations due to its mechanically driven nature.

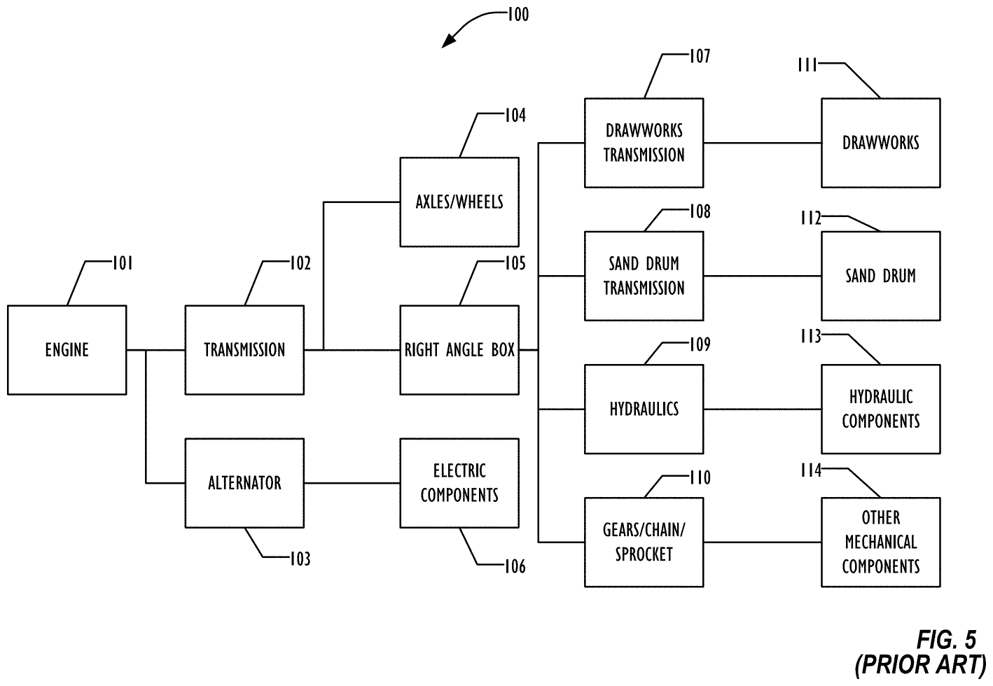

To power the rig via an electric input (e.g., a battery energy storage system or generators), the mechanical system needs modification. On a prior art mechanical rig 100 such as illustrated in FIG. 5, a main engine 101, typically a diesel engine, is connected to a transmission 102 via its crankshaft and flywheel/clutch/fluid coupling, which transfers engine power via a right-angle box 105 to a drawworks 111 via a drawworks transmission 107, a sand drum 112 via a sand drum transmission 108, hydraulics components 113 (e.g., mast hydraulics) via a hydraulics unit 109, and other mechanical components 114 via gears, chains, or sprockets 110, and to axles and wheels 104 of the rig 100. In addition, the main engine 101 may drive an alternator or generator 103 that converts mechanical energy into electrical energy to provide electrical power to electric components 106.

The engine 101 is the main power source (prime mover) on the rig 100 which utilizes diesel fuel and converts chemical energy in the diesel fuel into mechanical energy. The transmission 102 transmits the mechanical energy from the engine 101 to the axles and wheels 104, the drawworks 111, the sand drum 112, hydraulic components 113, and other mechanical components 114 on the rig 100 via a right-angle box 105 and various transmissions, such as drawworks transmission 107 and sand drum transmission 108, a hydraulics unit 109, and gears, chain, pulley systems, etc. 110 that serve as interconnects between the engine 101 and the drawworks 111, sand drum 112, hydraulics components 113, and other mechanical components 114. The transmission 102 is also responsible for speed and torque control. An alternator or generator 103 may also be driven by the engine 101 to provide electricity for electric components 106.

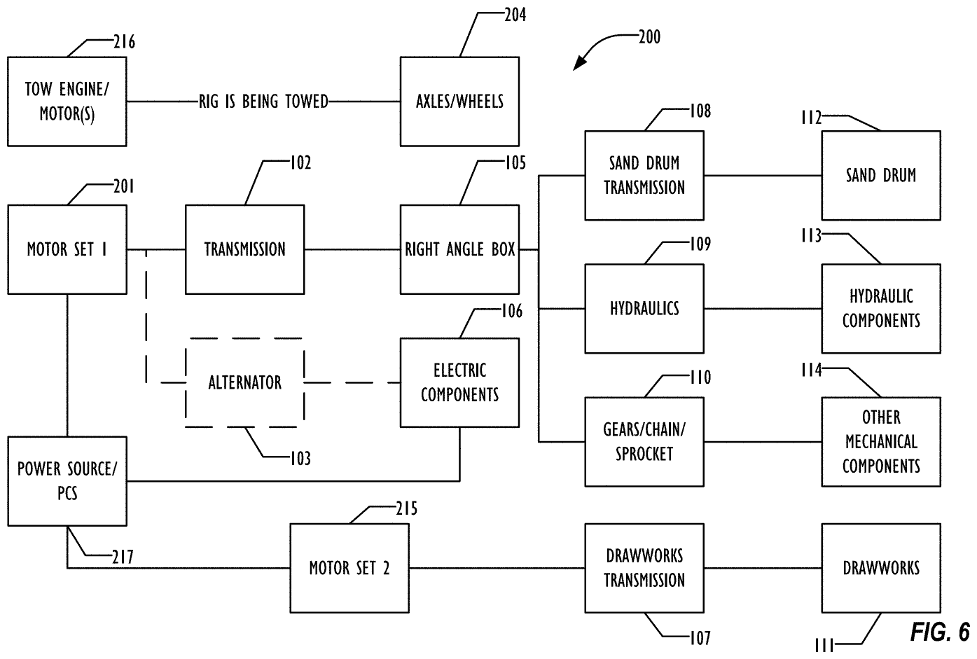

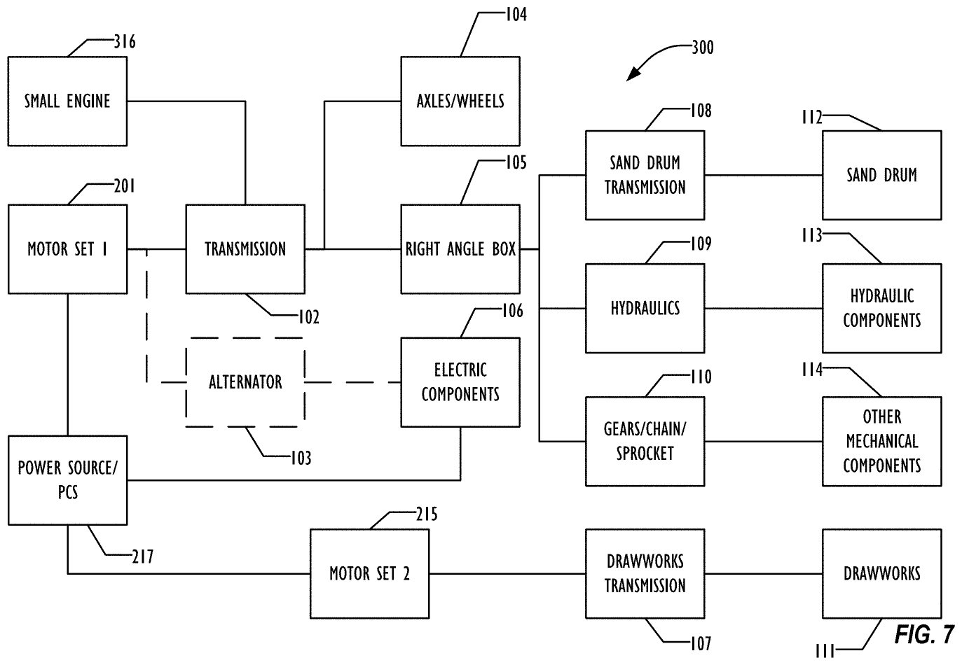

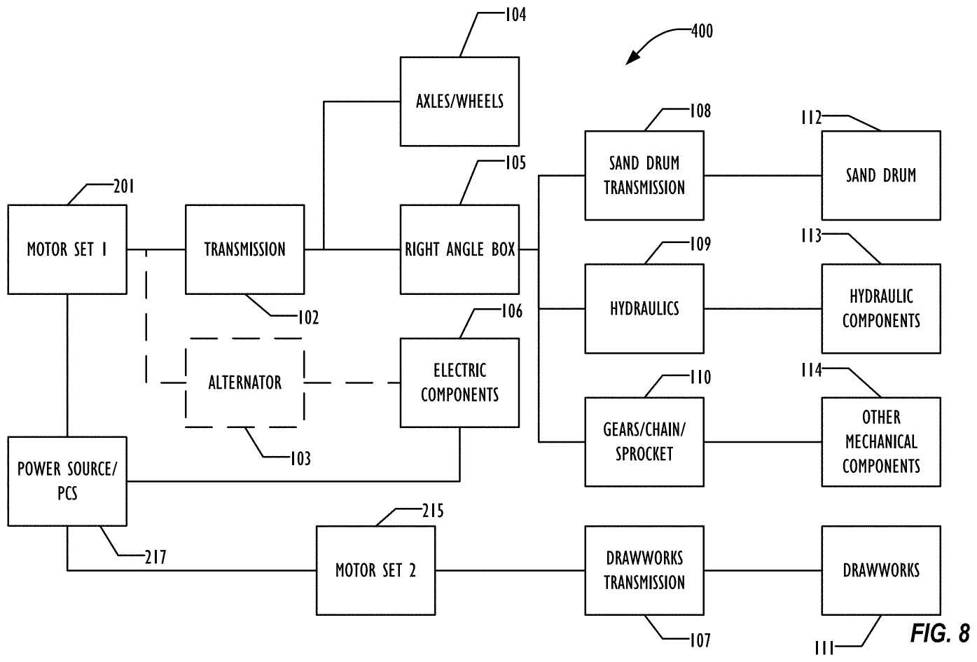

With a hybrid electro-mechanical workover rig, the need for the engine 101 may be much reduced if not eliminated, depending on the specific design. The retrofitted rig may be mounted on a trailer for the purposes of transportation, in which case the engine 101 may be eliminated altogether, as illustrated in the configuration of FIG. 6. Alternatively, in addition to adding the first motor set 201 and the second motor set 215, the existing engine 101 can either be replaced with a smaller sized engine 316, as in the self-propelled rig 300 illustrated in FIG. 7 or run with a smaller load with the sole purpose of transportation, by powering the axles of the equipment carrier (not shown). In the configuration illustrated in FIG. 8, the first motor set 401 is powerful enough to drive the axles and wheels 104 of the self-propelled rig 400, so no auxiliary combustion engine is needed. Although not illustrated in the figures, in some configurations the second motor set 215 may be eliminated and the entire rig driven by the first motor set 201.

As disclosed below, one or more electric motors may be installed, replacing the pre-existing engine 101. The electric motors will perform a similar functionality to the replaced engine 101 in driving the transmission 102 to power the components on the rig. In the embodiment of FIG. 6, the rig 200 is towed by a truck or other vehicle while electric motors power the remaining rig equipment.

A retrofit of the rig 200 as illustrated in FIG. 6 replaces the engine 101 with two motor sets, each comprising one or more electric motors, with a first motor set 201 replacing the engine 101 directly and a second motor set 215 independently driving the drawworks 111. A two-motor set design may provide higher efficiency and better control over the operations of the rig 200 than a single motor set design. Additional independent motor sets may be used as desired to power other components, such as a third motor set to drive the sand drum 112. depending on the equipment on the rig 200. Any desired type of electric motor may be used for the motor sets and either alternating current (AC) or direct current (DC) combined with a proper power conversion system may be used to power the electric motors as desired.

As illustrated in FIG. 6, the main engine 101 is disconnected from the transmission 102, removed, and replaced with a smaller capacity first motor set 201. The motor shaft size must be matched with the engine crankshaft size for easy replacement and connection with the main transmission 102 (or an adaptor is needed). The shaft size should be larger than the minimum shaft size such that it can bear the torsional shear and transfer the expected loads without breaking. The motor size is dictated by the equipment it must power. The first motor set 201 is designed to power the sand drum 112 (optional equipment), hydraulic components 113, and other mechanical components 114.

A drawworks transmission 107 for the drawworks 111 is typically a variable transmission that typically has four gear ratios: high-torque (high and low speed) and low-torque (high and low speed). The gear is shifted based on the operation currently underway. For example, a tripping operation from the bottom of the hole would have a heavy hook load so a suitable gear ratio might be high-torque low-speed.

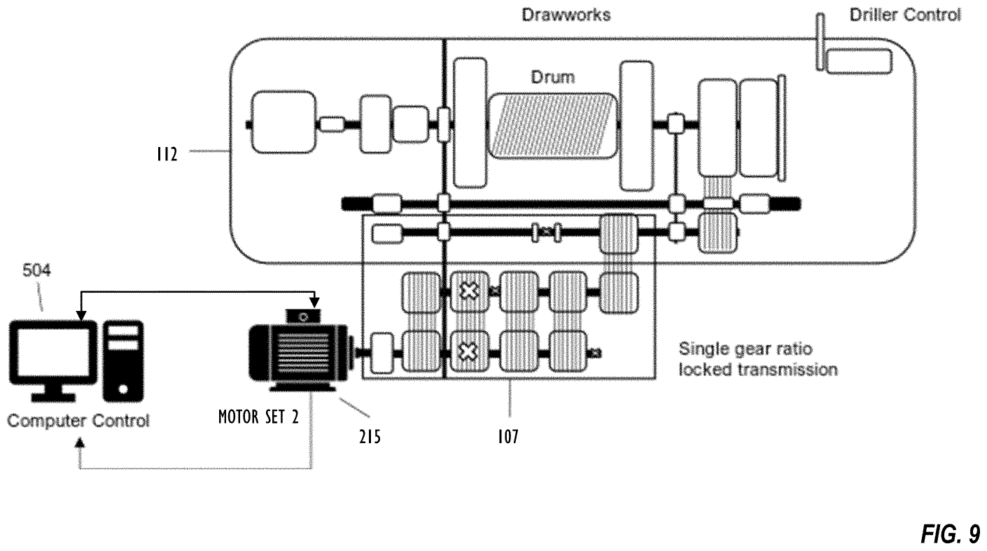

A technique for retrofitting the drawworks 111 is illustrated in FIG. 9. The drawworks transmission 107 is disconnected from the rig 200's main transmission 102. The drawworks transmission 107 is locked to a single gear ratio 502 and is connected to the second motor set 215, matching the motor shaft to replace the main transmission 102 shaft size with similar design considerations as described for the main engine replacement with the first motor set 201). This second motor set 215 is solely responsible for powering the drawworks 111.

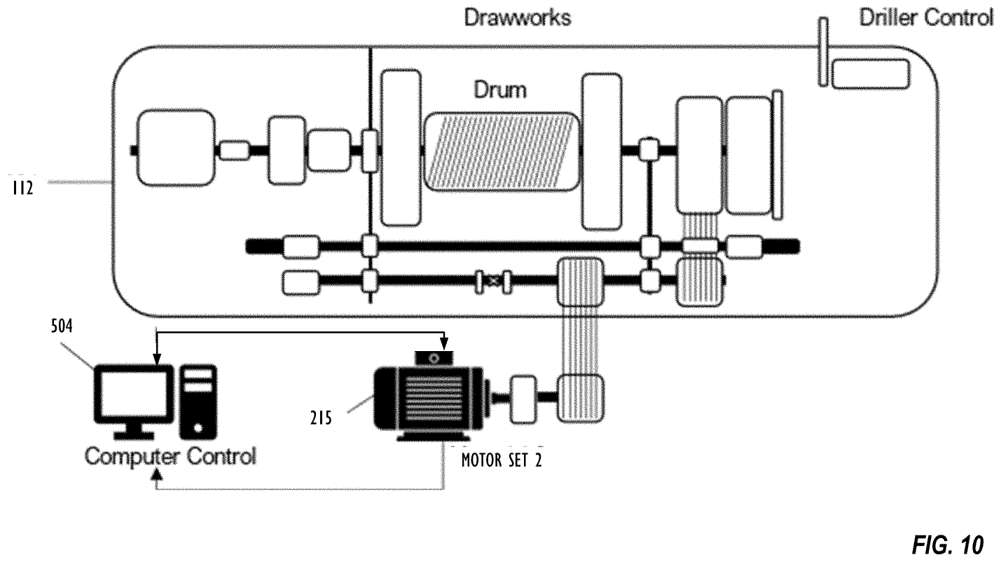

An alternate technique that may enhance control and precision is illustrated in FIG. 10. Instead of locking the drawworks transmission 107 into a single gear ratio as illustrated in FIG. 9, the drawworks transmission 107 is disconnected from the drawworks 111. Then, the second motor set 215 is connected directly to the drawworks 111, matching the motor shaft to replace the drawworks transmission 107 shaft size going to the drawworks 111 with similar design considerations as described for the main engine replacement with the first motor set 201.

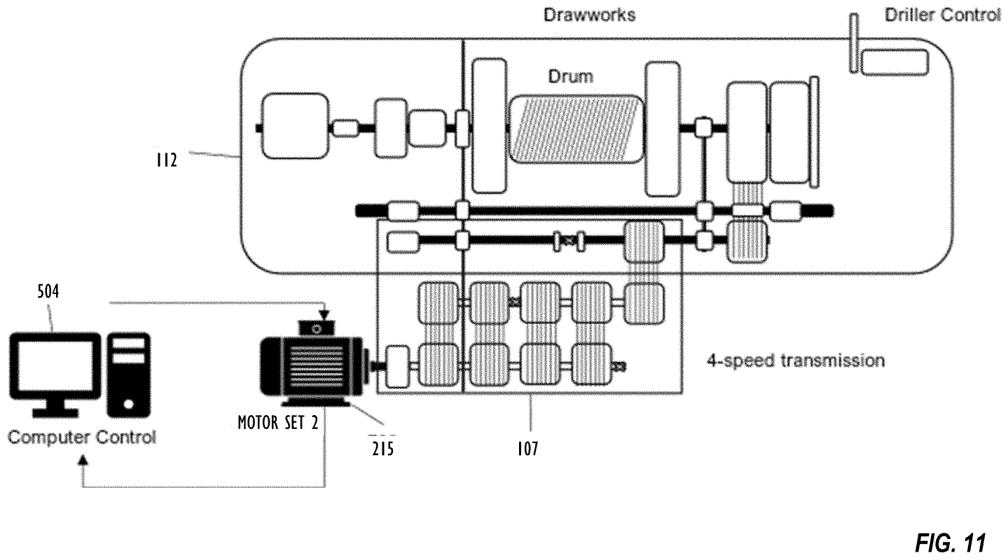

A third, simpler embodiment is illustrated in FIG. 11. Instead of locking the drawworks transmission 107 into a single gear ratio as illustrated in FIG. 9, the capability of the variable gear ratios is preserved. Then, the drawworks transmission 107 is connected to the second motor set 215, matching the motor shaft to replace the main transmission shaft size with similar design considerations as are described for the main engine 101 replacement with the first motor set 201. This second motor set 215 is solely responsible for powering the drawworks 111. This allows for using gear ratios like high-torque low-speed, or high-speed low-torque and distribute the wear and tear over all the gear ratios.

To drive the first motor set 201 and the second motor set 215, a power control system 217 may be installed to intake, regulate, and distribute power to the components of the rig 200. The power control system may integrate all the motor controllers for each motor in one place (shown) or may be present as separate units with each motor (not shown). If AC motors are used for the first motor set 201 or the second motor set 215, they may be connected to variable frequency drives (not shown) for speed and torque control. If DC motors are used for the first motor set 201 or the second motor set 215, a controller using thyristors, IGBTs, MOSFETs, other semiconductors (not shown) may be included as part of the power control system 217. An inverter (not shown) may also be used for the ancillary systems if they are AC electric or hydraulically run.

The electrical components 206 of the rig 200 are disconnected from the alternator or generator 103 (which is driven by the first motor set 201) and powered by directly connecting to the power source and power control system 217 for increased energy efficiency. Optionally, the alternator or generator 103 may be retained and continued to be powered by the first motor set 201 and the electrical components 106 run by the electricity generated by the alternator or generator 103.

Because the rig 200 of FIG. 6 is a trailer-mounted rig that is towed by a vehicle (not shown), the engine 216 of the vehicle provides towing power to the axle/wheels 204 of the rig 200, rather than driving them directly.

In some embodiments, the alternator or generator 103 may be eliminated, and electrical power provided from the power control system 217 to electric components 106. If the power control system 217 is alternating current (AC) and the electric components 106 are DC, a power converter such as an inverter (not shown) may be used. Alternately, the first motor set 201 may continue to drive an alternator or generator 103 for powering the electrical components 106 of the rig 200.

A computer control 504 that is software-driven may be added to the feedback loop of each of the motor controllers (not shown) for the motor on the rig, that assists in the oil and gas operations. The computer control 504 may be comprised of sensors and algorithmic-based software that assists in controlling acceleration, speeds, max allowed tension (force), partial cycling motions to assist in workover operations, and more. The computer control 504 may provide more precise control of the motor than possible with a mechanical transmission. This can improve operations by, for example, helping to minimize the occurrence of broken strings in a dilapidated wellbore situation that result in expensive fishing jobs.

Capacitors and flywheels (not shown) may be included to store excess energy within a regenerative braking system. These systems can be used to power the motors, reducing energy costs and further increasing operational efficiency.

While certain exemplary embodiments have been described in detail and shown in the accompanying drawings, it is to be understood that such embodiments are merely illustrative of and not devised without departing from the basic scope thereof, which is determined by the claims that follow.

We claim:

1. A modular system, comprising:
an electro-mechanical workover rig operable to use an electric power source instead of hydrocarbon fuels;
a battery energy storage system that powers all power requirements of the electro-mechanical workover rig, wherein the battery energy storage system is mobile, modular, and vibration resistant;
a power control system for one or both of
an alternating current drive of the electro-mechanical workover rig comprising a variable frequency drive; and
a direct current drive of the electro-mechanical workover rig comprising a controller; and
a custom software using artificial intelligence and predictive analytics that optimizes battery life and aids in power management based on a type of operation of the electro-mechanical workover rig.

2. The modular system of claim 1, wherein the battery energy storage system comprises:
an intermodal container, housing:
a plurality of batteries;
a plurality of battery racks on each of which are mounted batteries of the plurality of batteries;
a battery management system;
a cooling system;
a direct current input/output unit; and
a fire suppression system.

3. The modular system of claim 2, wherein the battery management system is configured to monitor battery health in individual battery cells of the plurality of batteries.

4. The modular system of claim 2, wherein the battery management system is configured to monitor battery health in an individual battery rack of the plurality of battery racks.

5. The modular system of claim 2, wherein the battery management system is configured to monitor battery health of the plurality of battery racks.

6. The modular system of claim 2, wherein the intermodal container comprises a plurality of doors located around the intermodal container to allow for direct access to the plurality of battery racks.

7. The modular system of claim 2, wherein the cooling system is a liquid cooling system.

8. The modular system of claim 2, wherein a battery rack of the plurality of battery racks comprises:
a passive vibration damper between a ceiling of the intermodal container and a top of the battery rack; and
a passive vibration damper between a floor of the intermodal container and a bottom of the battery rack.

9. The modular system of claim 2, wherein a battery rack of the plurality of battery racks comprises:
a dampening layer between the battery rack and batteries of the plurality of batteries that are mounted in the battery rack.

10. The modular system of claim 1, further comprising a step-up or step down transformer connected to the power control system.

11. A battery energy storage system that powers all power requirements of an electro-mechanical workover rig, comprising:
an intermodal container, housing:
a plurality of batteries;
a plurality of battery racks on each of which are mounted batteries of the plurality of batteries;
a battery management system;
a cooling system;
a direct current input/output unit; and
a fire suppression system, The batt
wherein the battery energy storage system is mobile, modular, and vibration resistant.

12. The battery energy storage system of claim 11, wherein the battery management system is configured to monitor battery health in individual battery cells of the plurality of batteries.

13. The battery energy storage system of claim 11, wherein the battery management system is configured to monitor battery health in an individual battery rack of the plurality of battery racks.

14. The battery energy storage system of claim 11, wherein the battery management system is configured to monitor battery health of the plurality of battery racks.

15. The battery energy storage system of claim 11, wherein the intermodal container comprises a plurality of doors located around the intermodal container to allow for direct access to the plurality of battery racks.

16. The battery energy storage system of claim 11, wherein the cooling system is a liquid cooling system.

17. The battery energy storage system of claim 11, wherein a battery rack of the plurality of battery racks comprises:
a passive vibration damper between a ceiling of the intermodal container and a top of the battery rack; and
a passive vibration damper between a floor of the intermodal container and a bottom of the battery rack.

18. The battery energy storage system of claim 11, wherein a battery rack of the plurality of battery racks comprises:
a dampening layer between the battery rack and batteries of the plurality of batteries that are mounted in the battery rack.

19. The battery energy storage system of claim 11, further comprising a step-up or step down transformer connected to a power control system for the electro-mechanical workover rig.

20. A method of powering an electro-mechanical workover rig, comprising:
powering all power requirements of the electro-mechanical workover rig with a mobile, modular, and vibration-resistant battery energy storage system;
controlling power for a variable frequency alternating current drive of the electro-mechanical workover rig; and
controlling power for a direct current drive of the electro-mechanical workover rig;
optimizing battery life and assisting in power management using artificial intelligence and predictive analytics, based on a type of operation of the electro-mechanical workover rig.
